(19) United States
(12) Patent Application Publication
(10) Pub. No.: US 2017/0121574 A1
(43) Pub. Date: May 4, 2017

(54) ADHESIVE COMPOSITION AND POLARIZING PLATE COMPRISING SAME

(71) Applicant: DONGWOO FINE-CHEM CO., LTD., Iksan-si, Jeollabuk-do (KR)

(72) Inventors: Han Young CHOI, Pyeongtaek-si (KR); Myungyoung AN, Incheon (KR)

(73) Assignee: DONGWOO FINE-CHEM CO., LTD., Iksan-si, Jeollabuk-do (KR)

(21) Appl. No.: 15/127,647

(22) PCT Filed: Mar. 23, 2015
(86) PCT No.: PCT/KR2015/002790

§ 371 Date: Sep. 20, 2016

(30) Foreign Application Priority Data
Mar. 28, 2014 (KR) 10-2014-0036504

(51) Int. Cl. C09J 133/06; G02B 5/30; B32B 27/30; G02F 1/1335; B32B 7/12

(52) U.S. Cl. CPC C09J 133/066; G02F 1/133528; B32B 7/12; B32B 27/306; G02B 5/3033; C08K 5/098

(57) ABSTRACT

The present invention provides an adhesive composition, comprising an alkali metal carboxylate containing a branched or alicyclic C₄₋₄₀ alkyl group as a cross-linking promoting agent, an acrylic copolymer, and a cross-linking agent, a polarizing plate and a liquid crystal display device comprising the adhesive composition. The adhesive composition according to the present invention has the great solubility of the cross-linking promoting agent in a solvent for adhesive coating, and can shorten a curing period to increase productivity and can inhibit the increase of peeling strength in a release film over time.

### TECHNICAL FIELD

The present invention relates to an adhesive composition and a polarizing plate comprising the same. Particularly, the present invention provides an adhesive composition that can shorten a curing period and inhibit the increase of peeling strength in a release film, and a polarizing plate and a liquid crystal display device comprising the adhesive composition.

### BACKGROUND ART

A liquid crystal display device (LCD) has a liquid crystal panel including a liquid crystal cell and polarizing plates laminated on both sides of the liquid crystal cell through adhesive layers.

The adhesive used to attach the polarizing plates to the liquid crystal cell should simultaneously satisfy adhesion to a substrate, prevention of light leakage, and durability such as heat resistance and heat/moisture resistance, as well as reworkability. Also, the adhesive is required to have a shortened curing period for the purpose of improving productivity.

In order to maintain the properties required as the adhesive and simultaneously shorten the curing period, the use of a cross-linking promoting agent for facilitating cross-linking reaction has been proposed.

For example, Korean Patent Application Publication No. 2009-0132116 discloses an adhesive composition comprising an amine compound such as dimethylaminopyridine as a cross-linking promoting agent so as to shorten a curing period. However, the adhesive composition has the problems that its storage stability becomes poor and the peeling strength of a release film increases.

### DISCLOSURE

### Technical Problem

It is an object of the present invention to provide an adhesive composition that can shorten a curing period and inhibit the increase of peeling strength in a release film.

It is another object of the present invention to provide a polarizing plate including an adhesive layer comprising the adhesive composition.

It is still another object of the present invention to provide a liquid crystal display device having the polarizing plate on at least one surface of a liquid crystal cell.

### Technical Solution

In accordance with one aspect of the present invention, there is provided an adhesive composition, comprising an alkali metal carboxylate containing a branched or alicyclic C₄₋₄₀ alkyl group as a cross-linking promoting agent, an acrylic copolymer, and a cross-linking agent.

In accordance with another aspect of the present invention, there is provided a polarizing plate including an adhesive layer comprising the adhesive composition.

In accordance with still another aspect of the present invention, there is provided a liquid crystal display device having the polarizing plate on at least one surface of a liquid crystal cell.

### Advantageous Effects

The adhesive composition of the present invention has the great solubility of the cross-linking promoting agent in a solvent for adhesive coating, and can shorten a curing period to increase productivity and can inhibit the increase of peeling strength in a release film over time.

### BEST MODE

The present invention is, hereinafter, described in more detail.

One embodiment of the present invention relates to an adhesive composition, comprising an alkali metal carboxylate containing a branched or alicyclic C₄₋₄₀ alkyl group as a cross-linking promoting agent, an acrylic copolymer, and a cross-linking agent.

In one embodiment of the present invention, the alkali metal carboxylate containing a branched alkyl group may be a salt of a carboxylic acid selected from the group consisting of formulas (1) to (19) and an alkali metal selected from the group consisting of Li, Na, K and Cs, which is commercially available.

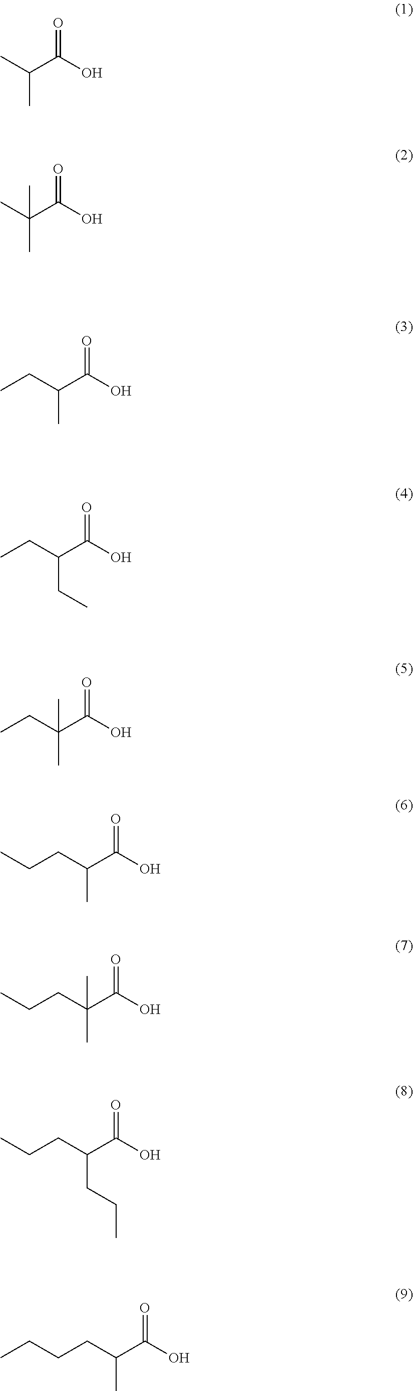

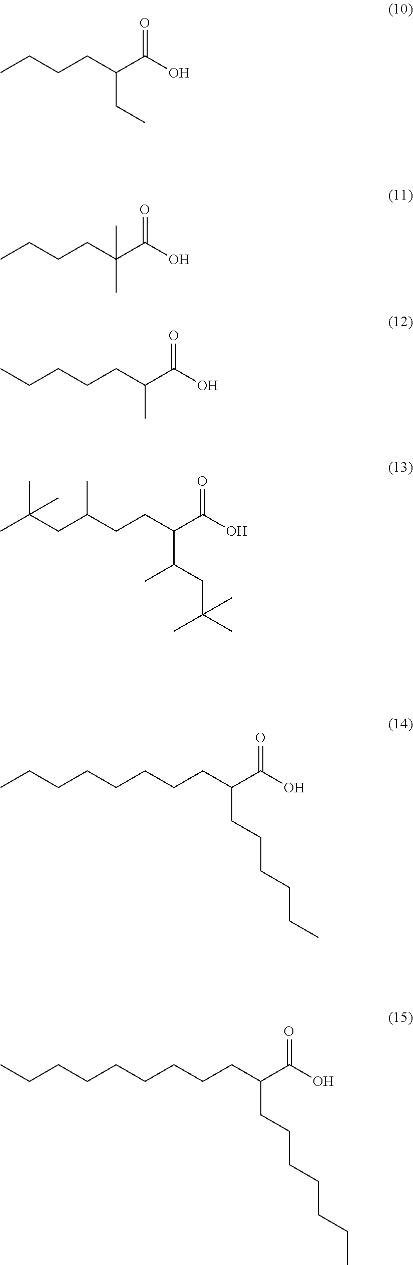

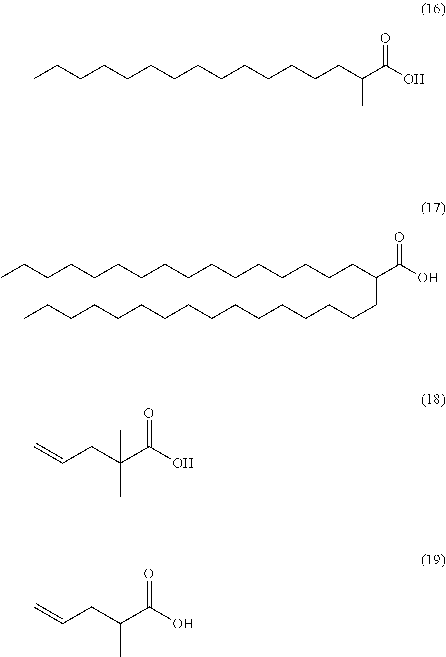

In one embodiment of the present invention, the alkali metal carboxylate containing an alicyclic alkyl group may be a salt of a carboxylic acid selected from the group consisting of formulas (20) to (33) and an alkali metal selected from the group consisting of Li, Na, K and Cs, which is commercially available.

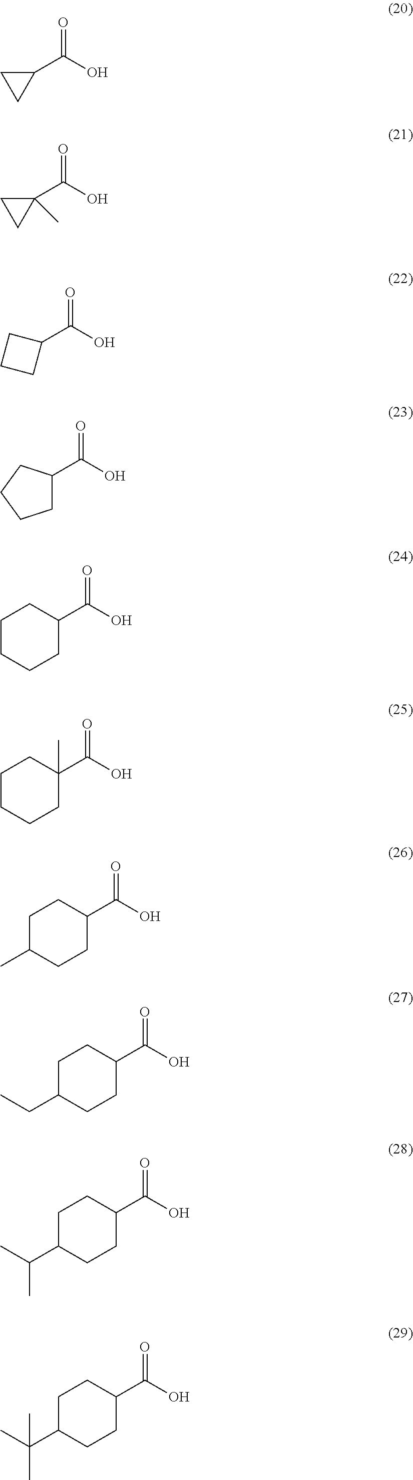

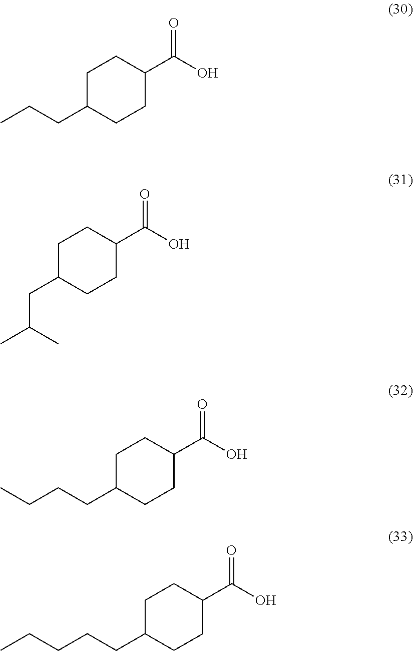

The alkali metal carboxylate containing a branched or alicyclic alkyl group may be present in an amount of 0.001 to 0.3 parts by weight, preferably 0.005 to 0.1 parts by weight, based on 100 parts by weight of the acrylic copolymer. If the amount of the alkali metal carboxylate is less than 0.001 parts by weight, the effect of promoting cross-linking reaction may be insufficient. If the amount of the alkali metal carboxylate is more than 0.3 parts by weight, the viscosity of the adhesive composition may increase over time.

In one embodiment of the present invention, the acrylic copolymer may comprise a (meth)acrylate monomer having a C₁₋₁₂ alkyl group and a polymeric monomer having a cross-linkable functional group.

As used herein, the term “(meth)acrylate” refers to acrylate and methacrylate.

Examples of the (meth)acrylate monomer having a C₁₋₁₂ alkyl group may include n-butyl (meth)acrylate, 2-butyl (meth)acrylate, t-butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, nonyl (meth)acrylate, decyl (meth)acrylate, lauryl (meth)acrylate, etc. Among these, n-butyl acrylate, 2-ethylhexyl acrylate, and a mixture thereof are preferred. These monomers may be used alone or in combination of two or more.

The polymeric monomer having a cross-linkable functional group is used to improve cohesive strength or adhesive strength of the composition through chemical bonding, thereby providing durability and cutting property, and may include a monomer having a hydroxyl group, a monomer having a carboxyl group, etc. These monomers may be used alone or in combination of two or more.

Examples of the monomer having a hydroxyl group may include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethyleneglycol (meth)acrylate, 2-hydroxypropyleneglycol (meth)acrylate, hydroxyalkyleneglycol (meth)acrylate having a C₂₋₄ alkylene group, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, etc. Among these, 2-hydroxyethyl (meth)acrylate and 4-hydroxybutyl vinyl ether are preferred.

Examples of the monomer having a carboxyl group may include monobasic acids such as (meth)acrylic acid and crotonic acid; dibasic acids such as maleic acid, itaconic acid and fumaric acid, and monoalkylesters thereof; 3-(meth)acryloylpropionic acid; succinic anhydride ring-opening adducts of 2-hydroxyalkyl (meth)acrylate having a C₂₋₃ alkyl group, succinic anhydride ring-opening adducts of hydroxyalkyleneglycol (meth)acrylate having a C₂₋₄ alkylene group, compounds obtained by ring-opening addition of succinic anhydride to caprolactone adduct of 2-hydroxyalkyl (meth)acrylate having a C₂₋₃ alkyl group, etc. Among these, (meth)acrylic acid is preferred.

In addition to the above monomers, the acrylic copolymer may further contain other monomers in a range not to degrade the adhesive strength, for example 10 wt % or less.

The copolymer can be prepared, without limitation, using bulk polymerization, solution polymerization, emulsion polymerization or suspension polymerization, etc. which are conventionally known in the art. Among these, the solution polymerization is preferred. Further, a solvent, a polymerization initiator, a chain transfer agent for controlling the molecular weight, etc. which are conventionally known in the art can be used for the polymerization.

The acrylic copolymer may have a polystyrene-converted weight average molecular weight of 50,000 to 2,000,000, preferably 400,000 to 2,000,000, as measured by gel permeation chromatography (GPC). If the weight average molecular weight is less than 50,000, the cohesiveness of the copolymer may be insufficient to degrade adhesive durability. If the weight average molecular weight is higher than 2,000,000, a large amount of a dilution solvent may be required to ensure the processability of a coating process.

In one embodiment of the present invention, the cross-linking agent is used to enhance adhesion and durability and to maintain reliability at a high temperature and the form of the adhesive. By way of examples, the cross-linking agent may include, without limitation, isocyanate compounds, epoxy compounds, peroxide compounds, metal chelate compounds, oxazoline compounds, etc. These compounds may be used alone or in combination of two or more. Among these, isocyanate compounds are preferred.

Specifically, diisocyanate compounds such as tolylene diisocyanate, xylene diisocyanate, hexamethylene diisocyanate, 2,4- or 4,4-diphenylmethane diisocyanate; and adducts of polyhydric alcohol compounds such as trimethylolpropane to diisocyanate compounds may be used.

In addition to the isocyanate cross-linking agent, at least one cross-linking agent selected from the group consisting of melamine derivatives such as hexamethylolmelamine, hexamethoxymethylmelamine, hexabutoxymethylmelamine, etc; polyepoxy compounds such as an epoxy compound obtained from condensation of bisphenol A and epichlorohydrin; polyglycidyl ether of polyoxyalkylene polyol, glycerol diglycidyl ether, glycerol triglycidyl ether, and tetraglycidyl xylylene diamine may be further used.

The cross-linking agent may be preferably contained in an amount of 0.1 to 15 parts by weight, more preferably 0.1 to 5 parts by weight, based on 100 parts by weight of the acrylic copolymer. If the amount of the cross-linking agent is less than 0.1 parts by weight, the cohesive strength may be decreased due to insufficient cross-linking, thereby resulting in durability deterioration and damaging cutting property. If the amount of the cross-linking agent is more than 15 parts by weight, the residual stress cannot be sufficiently relaxed due to excessive cross-linking.

The adhesive composition according to one embodiment of the present invention may further comprise a silane coupling agent.

In one embodiment of the present invention, the silane coupling agent may include, without limitation, vinylchlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyldiethoxysilane, 3-glycidoxypropyltriethoxysilane, p-styryltrimethoxysilane, 3-methacryloxypropyltriethoxysilane, 3-methacryloxypropyltrimethoxysilane, 3-methacryloxypropylmethyldimethoxysilane, 3-methacryloxypropylmethyldiethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropylmethyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, 3-chloropropyltrimethoxy silane, 3-mercaptopropylmethyl dimethoxysilane, 3-mercaptopropyltrimethoxysilane, bis(triethoxysilylpropyl)tetrasulfide, 3-isocyanatopropyltriethoxysilane, etc. These compounds may be used alone or in combination of two or more.

The silane coupling agent may be present in an amount of 0.01 to 5 parts by weight, preferably 0.1 to 5 parts by weight, based on 100 parts by weight of the acrylic copolymer. If the amount of the silane coupling agent is less than 0.01 parts by weight, it may be difficult to improve durability. If the amount of the silane coupling agent is more than 5 parts by weight, cohesive strength may excessively increase and adhesive properties may be degraded, thereby deteriorating durability.

The adhesive composition according to one embodiment of the present invention, if necessary, may further comprise an additive such as an adhesion enhancing resin, an antioxidant, an anti-corrosive agent, a leveling agent, a surface lubricant, a dye, a pigment, a defoaming agent, a filler, a light stabilizer, and an antistatic agent in order to control adhesion, cohesion, viscosity, elasticity, glass transition temperature, antistatic property, etc.

The adhesive composition of the present invention may be used for an adhesive for attaching a polarizing plate with a liquid crystal cell and an adhesive for a surface protective film. Also, the adhesive composition may be used for an adhesive for a protective film, a reflective sheet, an adhesive sheet for structures, an adhesive sheet for photographs, an adhesive sheet for traffic lanes, optical adhesive products, electronic parts, general adhesive sheet products, and medical patches.

One embodiment of the present invention relates to a polarizing plate including an adhesive layer comprising the adhesive composition as described above.

The thickness of the adhesive layer may vary depending on its adhesive strength, and preferably range from 3 to 100 μm, more preferably 10 to 100 μm.

Such a polarizing plate may be applied to typical liquid crystal display devices. Particularly, the polarizing plate may be used to fabricate a liquid crystal display device including a liquid crystal panel wherein the polarizing plate having the adhesive layer is laminated on at least one side of a liquid crystal cell.

Therefore, one embodiment of the present invention relates to a liquid crystal display device having the polarizing plate on at least one side of a liquid crystal cell.

The present invention is further illustrated by the following examples, comparative examples and experimental examples, which are not to be construed to limit the scope of the invention.

### Preparation Example 1: Preparation of Acrylic Copolymer

To a 1 L reactor equipped with a cooler and subjected to nitrogen gas flow were added a monomer mixture consisting of 88 parts by weight of n-butyl acrylate (BA), 7 parts by weight of methyl acrylate (MA), and 5 parts by weight of 2-hydroxyethyl acrylate, and then 100 parts by weight of ethyl acetate (EAc) as a solvent. Then, nitrogen gas was purged for 1 hour to remove oxygen, followed by maintaining the temperature to 62° C. After uniformly stirring the mixture, 0.07 parts by weight of azobisisobutyronitrile (AIBN) as a reaction initiator was added thereto, and the resulting mixture was reacted for 8 hours to give an acrylic copolymer (weight average molecular weight: about 1,000,000).

### Preparation Example 2: Preparation of Acrylic Copolymer

To a 1 L reactor equipped with a cooler and subjected to nitrogen gas flow were added a monomer mixture consisting of 90 parts by weight of n-butyl acrylate (BA), 5 parts by weight of methyl acrylate (MA), 4 parts by weight of 2-hydroxyethyl acrylate, and 1 part by weight of acrylic acid, and then 100 parts by weight of ethyl acetate (EAc) as a solvent. Then, nitrogen gas was purged for 1 hour to remove oxygen, followed by maintaining the temperature to 62° C. After uniformly stirring the mixture, 0.07 parts by weight of azobisisobutyronitrile (AIBN) as a reaction initiator was added thereto, and the resulting mixture was reacted for 8 hours to give an acrylic copolymer (weight average molecular weight: about 1,000,000).

### Experimental Example 1: Evaluation of Solubility

Each compound (1 g) listed in Table 1 and methyl ethyl ketone (MEK, 100 g) were added to a 250 ml bottle and covered with a cap to inhibit the volatilization of the solvent. After agitating it using a shaker at room temperature for 1 hour, the solution was left at room temperature for 24 hours. Then, the solution was visually confirmed whether an undissolved portion of the added compound was present. The results were shown in Table 1.

<Evaluation Criteria>

◯: Undissolved compound is not visually confirmed

x: Undissolved compound is visually confirmed

TABLE 1

| Compound | Structure | Solubility |
|---|---|---|
| Formula A | 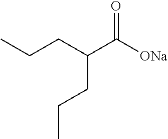 | ◯ |
| Formula B | 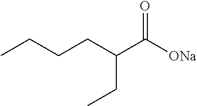 | ◯ |
| Formula C | 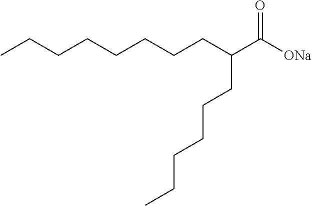 | ◯ |
| Formula D | 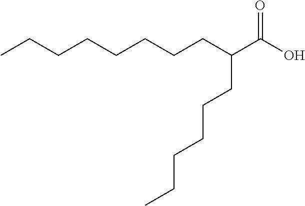 [SMILES: CCCCCCCCC(CCCCCC)C(=O)O] | ◯ |
| Formula E | 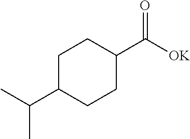 | ◯ |
| Formula F | 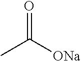 | X |
| Formula G | 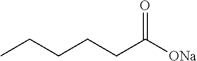 | X |
| Formula H | 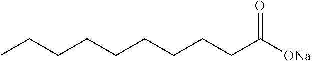 | X |
| Formula I | 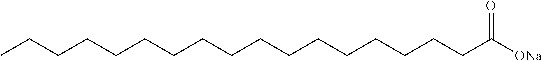 | X |
| Formula J | 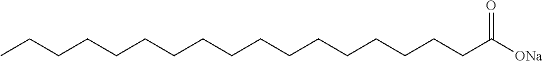 | X |

As shown in Table 1, the alkali metal carboxylate containing a branched alkyl group or an alicyclic alkyl group according to the present invention exhibited a significantly superior solubility in a solvent for adhesive coating, as compared with the alkali metal carboxylates containing a straight alkyl group, and thus it can be effectively used as a cross-linking promoting agent.

### Examples 1 to 13 and Comparative Examples 1 to 5

(1) Adhesive Composition

The components listed in Table 2 were mixed in parts by weight, and each mixture was diluted with ethyl acetate to give an adhesive composition having a solid concentration of 15%.

(2) Adhesive Sheet

Each adhesive composition thus obtained was applied on a silicon releasing agent-coated film so that the thickness is 25 μm after hardening, and dried at 100° C. for 1 minute to form an adhesive layer.

(3) Adhesive-Attached Polarizing Plate

The adhesive layer formed above was attached to an iodine polarizing plate with a thickness of 185 μm to prepare an adhesive-attached polarizing plate.

TABLE 2

| | | Cross-linking | Silane Coupling | Cross-linking |
|---|---|---|---|---|
| | Acrylic Coplymer | Agent | Agent | Promoting Agent |
| Example 1 | Preparation Example 1 (100) | Coronate-L(0.5) | KBM-403(0.5) | Formula A(0.001) |
| Example 2 | Preparation Example 1 (100) | Coronate-L(0.5) | KBM-403(0.5) | Formula A(0.01) |
| Example 3 | Preparation Example 1 (100) | Coronate-L(0.5) | KBM-403(0.5) | Formula A(0.1) |
| Example 4 | Preparation Example 1 (100) | Coronate-L(0.5) | KBM-403(0.5) | Formula C(0.001) |
| Example 5 | Preparation Example 1 (100) | Coronate-L(0.5) | KBM-403(0.5) | Formula C(0.01) |
| Example 6 | Preparation Example 1 (100) | Coronate-L(0.5) | KBM-403(0.5) | Formula C(0.1) |
| Example 7 | Preparation Example 2 (100) | Coronate-L(0.5) | KBM-403(0.5) | Formula A(0.01) |
| Example 8 | Preparation Example 2 (100) | Coronate-L(0.5) | KBM-403(0.5) | Formula C(0.01) |
| Example 9 | Preparation Example 1 (100) | Coronate-L(0.5) | KBM-403(0.5) | Formula B(0.01) |
| Example 10 | Preparation Example 2 (100) | Coronate-L(0.5) | KBM-403(0.5) | Formula E(0.01) |
| Example 11 | Preparation Example 1 (100) | Coronate-L(0.5) | KBM-403(0.5) | Formula A(0.5) |
| Example 12 | Preparation Example 1 (100) | Coronate-L(0.5) | KBM-403(0.5) | Formula D(0.01) |
| Example 13 | Preparation Example 1 (100) | Coronate-L(0.5) | KBM-403(0.5) | Formula E(0.01) |
| Com. | Preparation Example 1 (100) | Coronate-L(0.5) | KBM-403(0.5) | Formula F(0.01) |
| Example 1 | | | | |
| Com. | Preparation Example 2 (100) | Coronate-L(0.5) | KBM-403(0.5) | Formula G(0.01) |
| Example 2 | | | | |
| Com. | Preparation Example 1 (100) | Coronate-L(0.5) | KBM-403(0.5) | Formula H(0.01) |
| Example 3 | | | | |
| Com. | Preparation Example 1 (100) | Coronate-L(0.5) | KBM-403(0.5) | Formula I(0.01) |
| Example 4 | | | | |
| Com. | Preparation Example 1 (100) | Coronate-L(0.5) | KBM-403(0.5) | Dimethylamino- |
| Example 5 | | | | pyridine (0.1) |

Cross-linking Agent: Coronate-L (Nippon Polyurethane Industry)
Silane Coupling Agent: KBM-403 (Shin-Etsu)

### Experimental Example 2: Evaluation of Curing Period and Peeling Strength of Release Film

The adhesive compositions, adhesive sheets and adhesive-attached polarizing plates prepared in the Examples and Comparative Examples were measured for their physical properties using the following methods, and the results were shown in Table 3.

(1) Curing Period

The prepared adhesive sheet was cured for 1 to 10 days under the condition of 23° C. and 65% RH. During curing, the gel fraction was calculated according to the following method in 6 hours, 12 hours, 18 hours and daily, and the curing period was determined as the time when the value of the calculated gel fraction is fallen in the range of 70 to 80% and there is no change over time.

About 0.25 g of the adhesive layer of the cured adhesive sheet was attached in a precisely weighed wire mesh (100 mm×100 mm) having a 250 mesh size, and was well sealed so that the gel was not leaked. The weight of the wire mesh was precisely measured, and then the wire mesh was immersed in a solution of ethyl acetate for 3 days. The immersed wire mesh was taken out and washed with a small amount of ethyl acetate, and dried at 120° C. for 24 hours. After drying, the weight of the wire mesh was again measured. The measured weights were used in the following equation (1) to calculate the gel fraction.

Gel Fraction (%)=(C−A)/(B−A)×100 [Equation 1]

wherein A is a weight (g) of the wire mesh, B is a weight of the adhesive-attached wire mesh (B−A: a weight (g) of the adhesive), and C is a weight of the dried wire mesh after immersing (C−A: a weight (g) of the gelated resin).

(2) Variation of Peeling Strength of Release Film

The prepared adhesive sheet was cut into a size of 50 mm×100 mm give a sample. The sample was measured for its peeling strength (W₁) by peeling a release film at a peel rate of 300 mm/min and a peel angle of 180° using a universal testing machine (UTM, Instron). Also, after the sample was left at 70° C. for 3 days, the peeling strength (W₂) was measured in the same manner as described above. The measured values were used to calculate the variation of peeling strength.

Variation (%) of Peeling Strength=(W₂−W₁)/W₁×100 [Equation 2]

TABLE 3

| | | | Variation (%) |
|---|---|---|---|
| | Curing | | of Peeling |
| | Period | | Strength |
| Example 1 | 2 | days | 12% |
| Example 2 | 1 | day | 23% |
| Example 3 | 12 | hours | 30% |
| Example 4 | 2 | days | 9% |
| Example 5 | 1 | day | 21% |
| Example 6 | 18 | hours | 28% |
| Example 7 | 1 | day | 24% |
| Example 8 | 1 | day | 22% |
| Example 9 | 1 | day | 24% |
| Example 10 | 1 | day | 21% |
| Example 11 | 6 | hours | 45% |
| Example 12 | 1 | day | 26% |
| Example 13 | 1 | day | 19% |
| Com. Example 1 | 10 | days | 5% |
| Com. Example 2 | 5 | days | 12% |
| Com. Example 3 | 10 | days | 4% |
| Com. Example 4 | 10 | days | 7% |
| Com. Example 5 | 1 | day | 150% |

As shown in Table 3, the adhesive compositions of Examples 1 to 13 wherein the alkali metal carboxylate containing a branched alkyl group or an alicyclic alkyl group according to the present invention was used as a cross-linking promoting agent exhibited a significantly shortened curing period as compared with those of Comparative Examples 1 to 4 wherein an alkali metal carboxylate containing a straight alkyl group was used as the cross-linking promoting agent, and exhibited a lower variation (%) of peeling strength as compared with that of Comparative Example 5 using dimethylaminopyridine as a cross-linking promoting agent.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

1. An adhesive composition, comprising an alkali metal carboxylate containing a branched or alicyclic C₄₋₄₀ alkyl group as a cross-linking promoting agent, an acrylic copolymer, and a cross-linking agent.

2. The adhesive composition of claim 1, wherein the alkali metal carboxylate containing a branched alkyl group is a salt of a carboxylic acid selected from the group consisting of formulas (1) to (19) and an alkali metal selected from the group consisting of Li, Na, K and Cs:

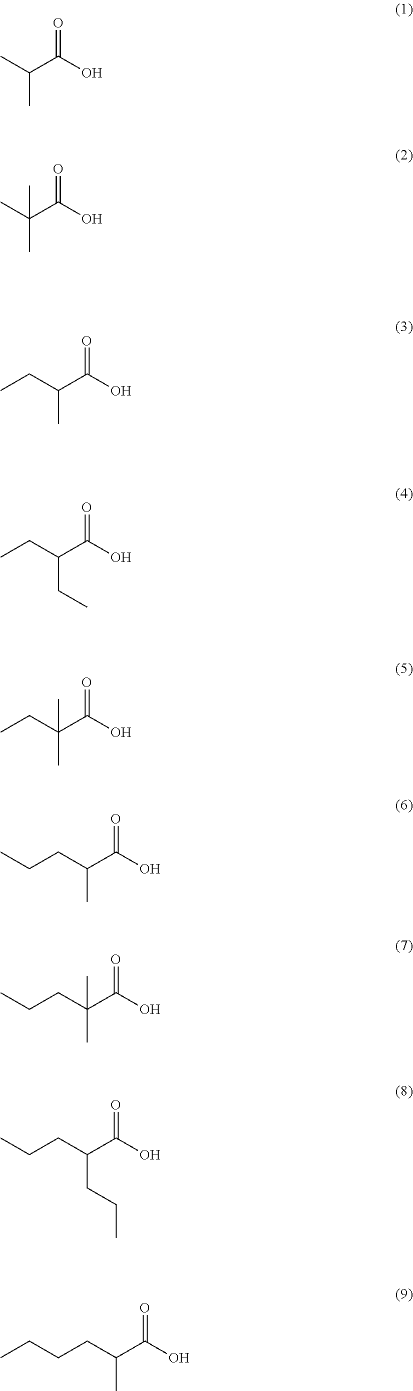

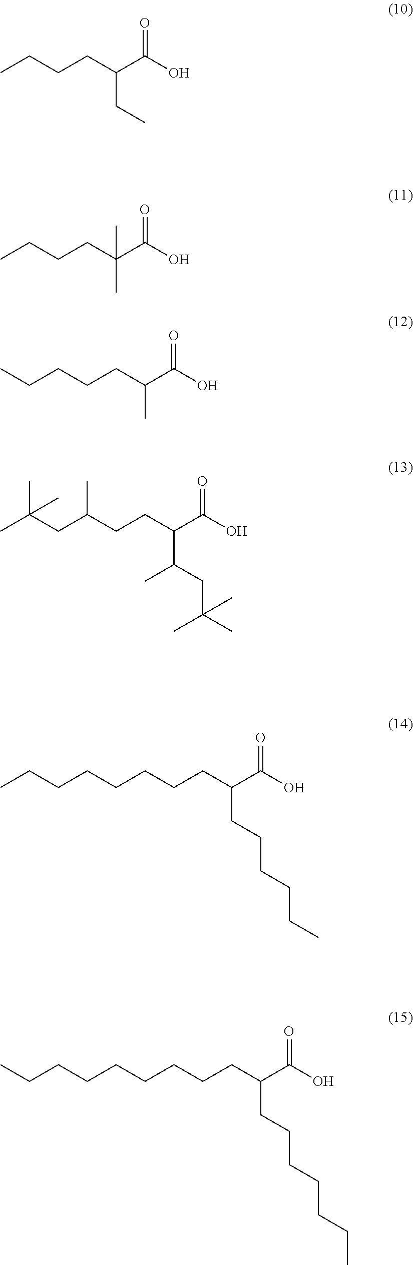

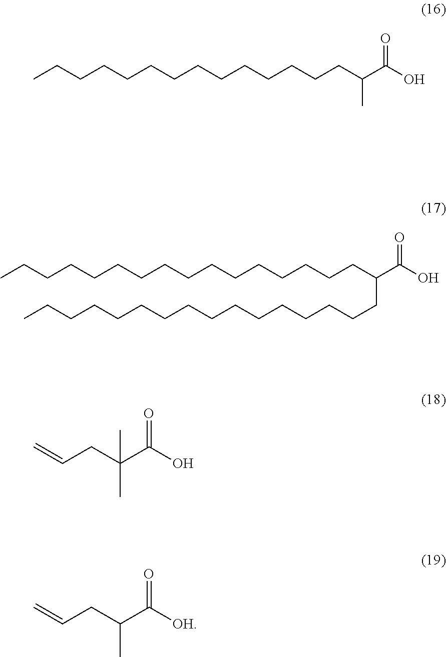

3. The adhesive composition of claim 1, wherein the alkali metal carboxylate containing an alicyclic alkyl group is a salt of a carboxylic acid selected from the group consisting of formulas (20) to (33) and an alkali metal selected from the group consisting of Li, Na, K and Cs:

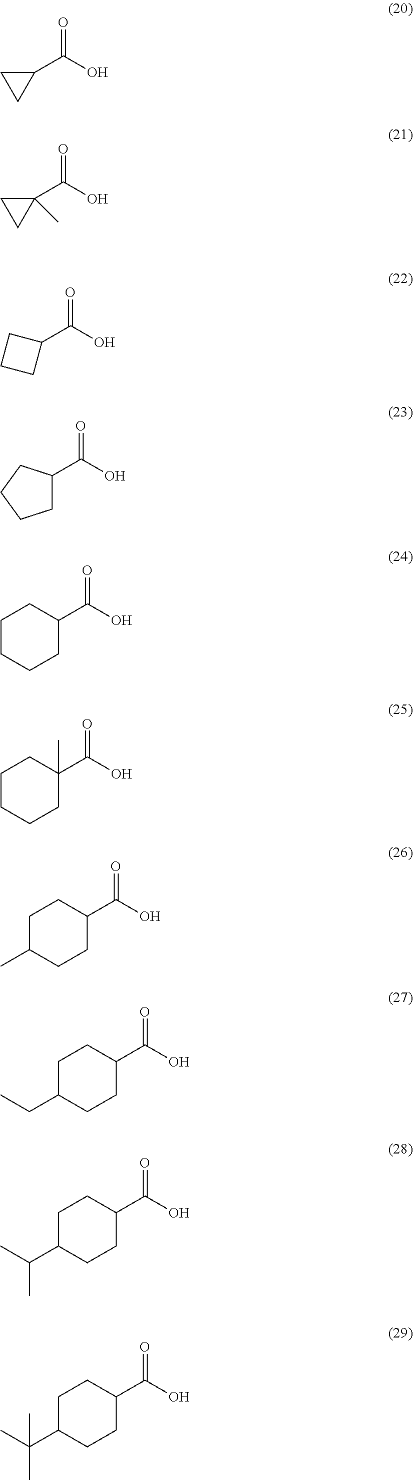

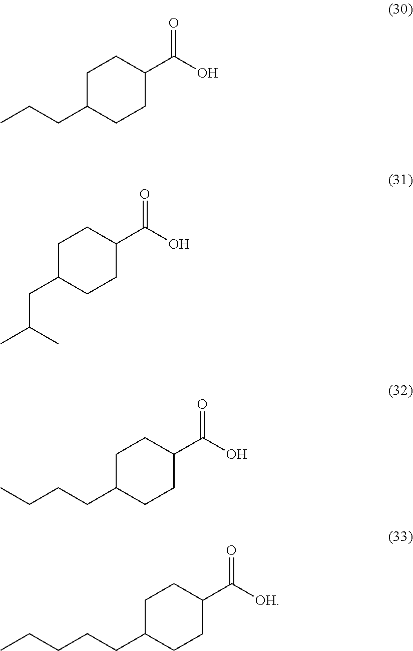

4. The adhesive composition of claim 1, wherein the alkali metal carboxylate containing a branched or alicyclic alkyl group is present in an amount of 0.001 to 0.3 parts by weight based on 100 parts by weight of the acrylic copolymer.

5. A polarizing plate, including an adhesive layer comprising the adhesive composition of claim 1.

6. A liquid crystal display device having the polarizing plate of claim 5 on at least one side of a liquid crystal cell.

7. A polarizing plate, including an adhesive layer comprising the adhesive composition of claim 2.

8. A liquid crystal display device having the polarizing plate of claim 7 on at least one side of a liquid crystal cell.

9. A polarizing plate, including an adhesive layer comprising the adhesive composition of claim 3.

10. A liquid crystal display device having the polarizing plate of claim 9 on at least one side of a liquid crystal cell.

11. A polarizing plate, including an adhesive layer comprising the adhesive composition of claim 4.

12. A liquid crystal display device having the polarizing plate of claim 11 on at least one side of a liquid crystal cell.
